(19) United States
(12) Patent Application Publication
(10) Pub. No.: US 2006/0076409 A1
(43) Pub. Date: Apr. 13, 2006

(54) Card reading apparatus

(76) Inventor: Sheng-Ching Ko, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/962,420

(22) Filed: Oct. 13, 2004

(51) Int. Cl. G06K 7/06

(52) U.S. Cl. 235/441

(57) ABSTRACT

A card reading apparatus for insertion of an electronic card therein has an insulating housing and a set of control terminals. The insulating housing has an insertion space formed therein. The set of control terminals has a first control terminal and a second control terminal. The first control terminal has a first retaining portion and a first elastic arm. The first elastic arm has a push portion and an elongation portion. The second control terminal has a second retaining portion. A free end of the elongation portion is disposed at a corresponding lateral side of the second retaining portion to form a gap therebetween in a normal status. When the electronic card is inserted into the insertion space, the electronic card pushes the push portion, such that the free end of the elongation portion moves toward the second retaining portion and slidably contacts thereon.

### BACKGROUND OF THE INVENTION

1. Field of the Invention

The present invention relates to a card reading apparatus, and more particularly, to a card reading apparatus having a set of control terminals that detects an insertion status of an electronic card inserted therein.

2. Description of Related Art

It is well known that electronic cards are commonly applied to various electronic products, such as cellular phones, personal digital assistants, or digital cameras. Every electronic product has a card reading apparatus for insertion of an electronic card therein, such as an SD (Secured Digital) card, such that the electronic card electrically contacts a corresponding set of terminals of the card reading apparatus. In order to maintain a normal and a requested signal transmission between the electronic card and the set of terminals, and to avoid erasing data in the electronic card carelessly, the card reading apparatus has to detect the insertion status of the electronic card, so as to ensure the electronic contacts between the electronic card and the set of terminals, and to provide an anti-write protective function.

A conventional card reading apparatus for insertion of an electronic card therein includes an insulating housing and a set of control terminals. The insulating housing has an insertion space formed therein for insertion of the electronic card. The set of control terminals includes a protective terminal and a common terminal. The protective terminal has a retaining portion, an elastic arm, and a soldering portion. The retaining portion is positioned in the insulating housing. The elastic arm has a push portion and a pressing portion. The push portion has a fixing end at an end thereof connecting with the retaining portion, and a movable end at another end thereof extending into the insertion space. The pressing portion has an end connecting with the movable end of the push portion to form a bent point, and a free end at another end thereof. The soldering portion connects with the retaining portion for soldering on a printed circuit board. The common terminal has a retaining portion positioned in the insulating housing, and a soldering portion for soldering on the printed circuit board. The free end of the pressing portion of the elastic arm of the protective terminal is disposed at a corresponding lateral side of the retaining portion of the common terminal to form a gap therebetween in a normal status.

When the electronic card is inserted into the insertion space, the electronic card pushes the push portion of the elastic arm of the protective terminal, such that the free end of the pressing portion of the protective terminal moves toward the retaining portion of the common terminal and contacts thereon. When the electronic card is in position, a place of an anti-write element of the electronic card determines if the anti-write element presses against the bent point of the elastic arm of the protective terminal, thereby determining if the free end of the pressing portion of the elastic arm contacts the retaining portion of the common terminal, and thereby ensuring that the electronic card is in an anti-write protective status. Because the pressing portion is short, its free end can only move toward the common terminal, and the force against on the elastic arm and the deformation of the elastic arm concentrate on the push portion, which causes great damage of the elastic arm and increases a resistant force when insertion of the electronic card and results in an unsmooth insertion as well. If the elasticity of the elastic arm is reduced, the contact between the protective terminal and the common terminal is not confirmable.

Accordingly, as discussed above, the conventional card reading apparatus still has some drawbacks that could be improved. The present invention aims to resolve the drawbacks in the prior art.

### SUMMARY OF THE INVENTION

The primary object of the invention is therefore to specify a card reading apparatus having a set of control terminals with a smooth and confirmable contact between the control terminals thereof and that is durable, so that an electronic card is much more easily inserted therein.

According to the invention, the object is achieved via a card reading apparatus for insertion of an electronic card therein. The card reading apparatus comprises an insulating housing and a set of control terminals. The insulating housing has an insertion space formed therein and an insertion opening formed in a front thereof. The insertion opening communicates with the insertion space. The electronic card is inserted into the insertion space through the insertion opening. The set of control terminals includes a first control terminal and a second control terminal. The first control terminal has a first retaining portion and a first elastic arm. The first retaining portion is positioned in the insulating housing. The first elastic arm has a push portion and an elongation portion. The push portion has a fixing end at an end thereof connecting with the first retaining portion. The push portion has a movable end at another end thereof extending into the insertion space and toward a rear of the insulating housing. The elongation portion has an end connecting with the movable end of the push portion to form a bent point. The elongation portion has a free end at another end thereof. The second control terminal has a second retaining portion. The second retaining portion is positioned in the insulating housing. The free end of the elongation portion is disposed at a corresponding lateral side of the second retaining portion to form a gap therebetween in a normal status. When the electronic card is inserted into the insertion space, the electronic card pushes the push portion, moving the free end of the elongation portion toward the second retaining portion to contact slidably thereon.

The elongation portion of the first elastic arm of the first control terminal contacts the second retaining portion of the second control terminal in a slidable contacting manner, so that the first control terminal has a better elasticity to avoid concentrating the force on the first elastic arm and a deformation of the first elastic arm on the push portion. Therefore, the contact between the first control terminal and the second control terminal is much smoother and much more confirmable, the control terminals are much more durable, and the electronic card is much more easily inserted in the card reading apparatus.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an exploded perspective view of a card reading apparatus of the present invention;

FIG. 2 is a schematic perspective view of a set of control terminals of a card reading apparatus of the present invention;

FIG. 3 shows a schematic perspective view of an electronic card and a set of control terminals of a card reading apparatus of the present invention when the electronic card is inserted into the card reading apparatus;

FIG. 4 shows another schematic perspective view of an electronic card and a set of control terminals of a card reading apparatus of the present invention when the electronic card is inserted into the card reading apparatus;

FIG. 5 shows a schematic top planar view of an electronic card and a set of control terminals of a card reading apparatus of the present invention when the electronic card is inserted into the card reading apparatus;

FIG. 6 shows a schematic side view of an electronic card and a set of control terminals of a card reading apparatus of the present invention when the electronic card is inserted into the card reading apparatus;

FIG. 7 is an exploded perspective view of a card reading apparatus of another embodiment of the present invention; and

FIG. 8 is a schematic perspective view of a set of control terminals of a card reading apparatus of another embodiment of the present invention.

### DETAILED DESCRIPTION OF THE EMBODIMENTS

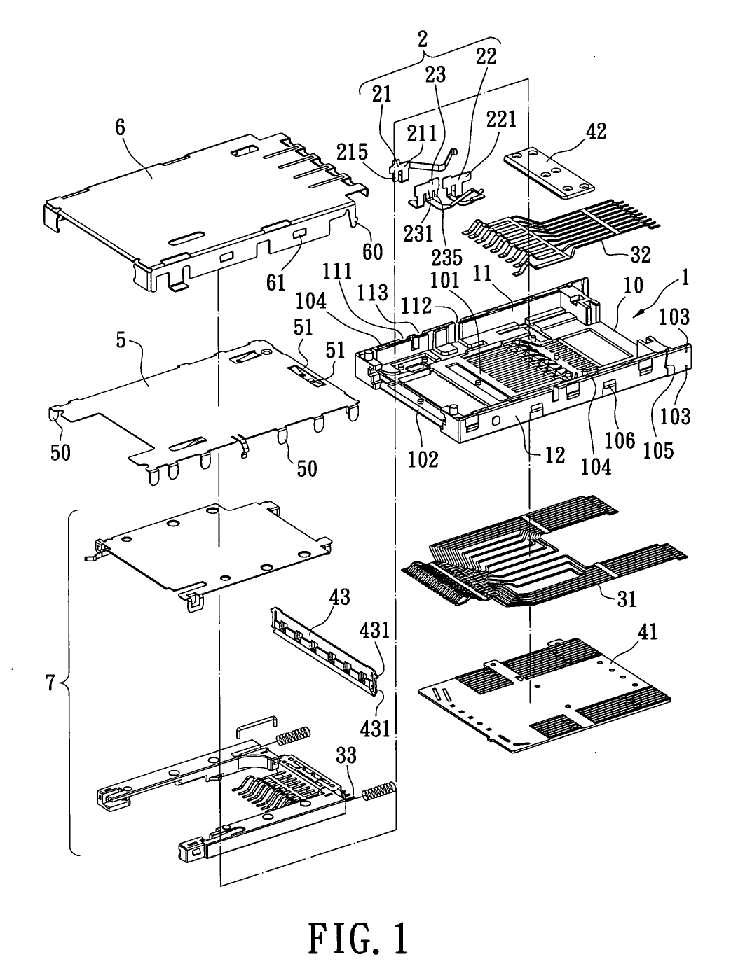

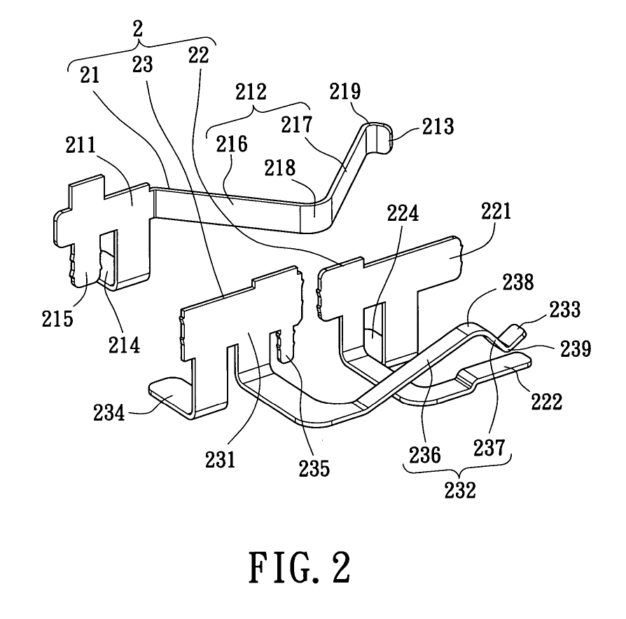

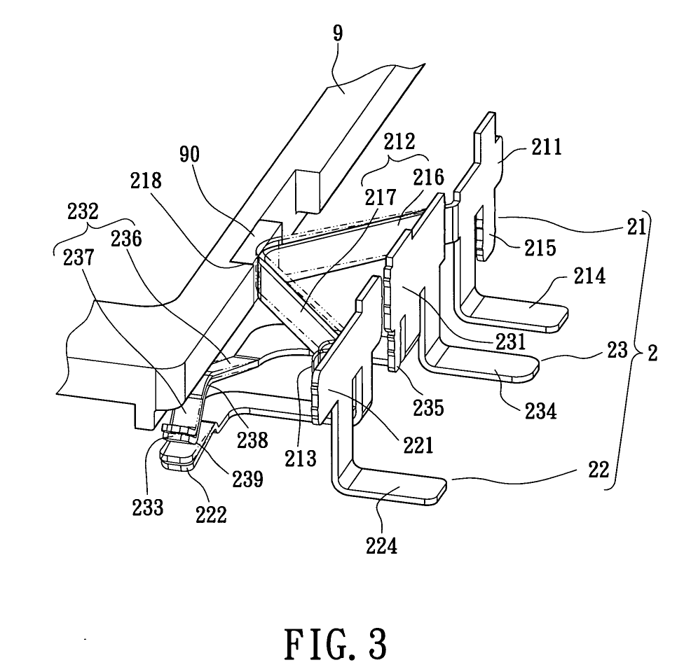

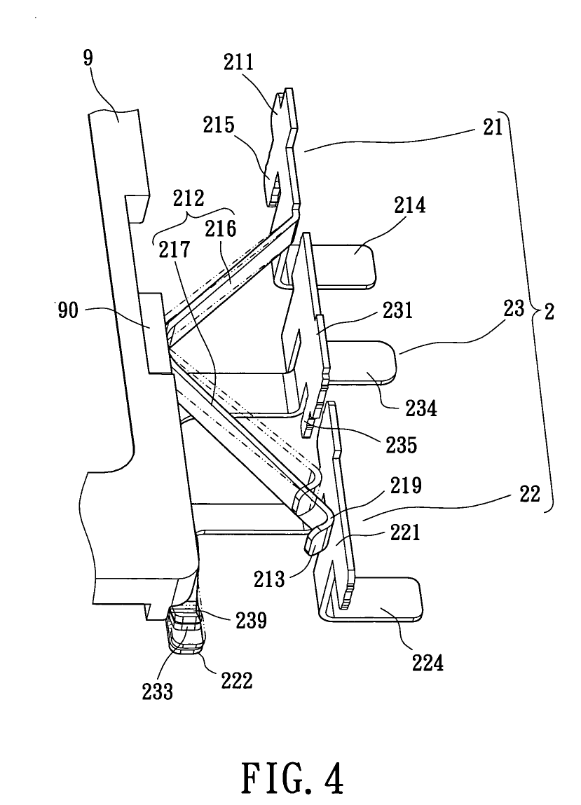

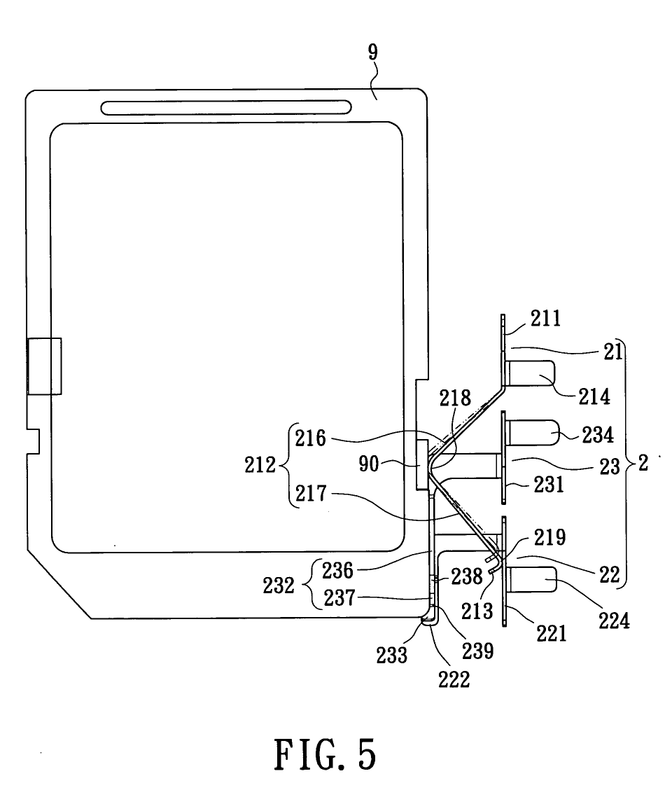

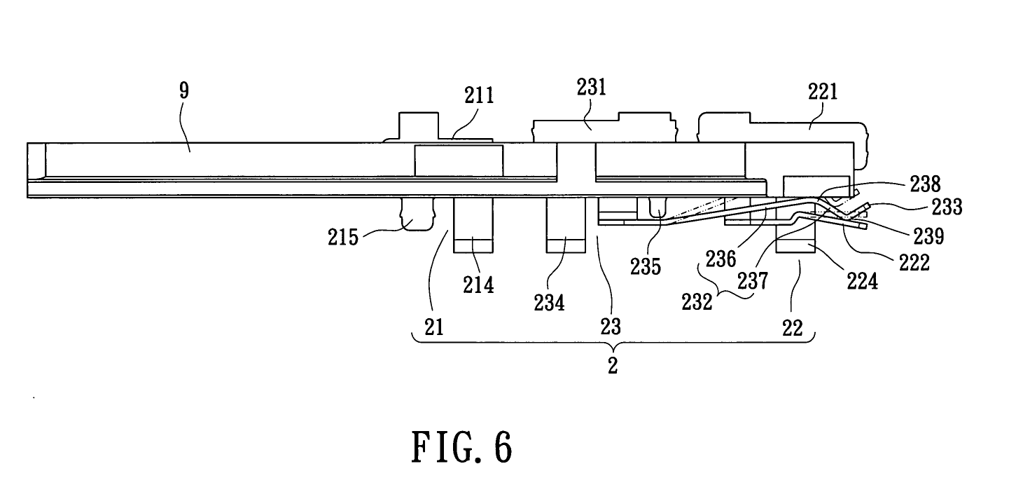

Referring to FIG. 1 and FIG. 2, the present invention provides a card reading apparatus for insertion of an electronic card 9 (shown in FIGS. 3-6) therein. The card reading apparatus comprises an insulating housing 1 and a set of control terminals 2. In this embodiment, the card reading apparatus also comprises a first set of terminals 31, a second set of terminals 32, a third set of terminals 33, a first pressing plate 41, a second pressing plate 42, a rear pressing plate 43, a cover 5, a shielding casing 6, and a card ejection mechanism 7.

The insulating housing 1 has an insertion space 101 formed therein and an insertion opening 102 formed in a front thereof. The insertion opening 102 communicates with the insertion space 101, and the electronic card 9 is inserted into the insertion space 101 through the insertion opening 102. In this embodiment, the insulating housing 1 has a base plate 10, a first sidewall 11, and a second sidewall 12. The first sidewall 11 and the second sidewall 12 respectively connect with two opposite edges of the base plate 10 to form the insertion space 101 of the insulating housing 1 therebetween. The first sidewall 11 has a first recess 111, a second recess 112, and a third recess 113. The first recess 111, the third recess 113, and the second recess 112 are arranged in sequence backward from the front of the insulating housing 1. Each of the first sidewall 11 and the second sidewall 12 has two holding slots 103 disposed at rear ends thereof.

The set of control terminals 2 includes a first control terminal 21, a second control terminal 22, and a third control terminal 23. In this embodiment, the first control terminal 21 is a protective terminal, the second control terminal 22 is a common terminal, and the third control terminal 23 is a detective terminal. The protective terminal is for confirmation of an anti-write protective status of the electronic card 9, so as to avoid carelessly erasing data stored in the electronic card 9. The detective terminal is for confirmation of reaching a positioning status of the electronic card 9, so as to assure a normal signal transmission to the electronic card 9.

The first control terminal 21 has a first retaining portion 211, a first elastic arm 212, a raised portion 213, and a first soldering portion 214. The first retaining portion 211 has an insertion tab 215. The first retaining portion 211 is positioned in the first recess 111 of the insulating housing 1, and the insertion tab 215 is embedded in the first recess 111 to enhance its retention force. The first elastic arm 212 has a push portion 216 and an elongation portion 217. In this embodiment, the push portion 216 has a length equal to that of the elongation portion 217, but this is not to be construed as a limitation; for example, there may be a slight difference between the lengths thereof. The push portion 216 has a fixing end at an end thereof connecting with the first retaining portion 211. The push portion 216 has a movable end at another end thereof extending into the insertion space 101 and toward a rear of the insulating housing 1. The elongation portion 217 has an end connecting with the movable end of the push portion 216 to form a bent point 218. The elongation portion 217 has a free end 219 at another end thereof. The raised portion 213 connects with the free end 219 of the elongation portion 217. The first soldering portion 214 connects with the first retaining portion 211 and extends out of the insertion space 101.

The second control terminal 22 has a second retaining portion 221, a second elastic arm 222, and a second soldering portion 224. The second retaining portion 221 is positioned in the second recess 112 of the insulating housing 1. The second elastic arm 222 has a fixing end at an end thereof connecting with the second retaining portion 221. The second elastic arm 222 has a free end at another end thereof extending into the insertion space 101 and the rear of the insulating housing 1. The second soldering portion 224 connects with the second retaining portion 221 and extends out of the insertion space 101. The free end 219 of the elongation portion 217 of the first control terminal 21 is disposed at a corresponding lateral side of the second retaining portion to form a gap therebetween in a normal status. The raised portion 213 of the first control terminal 21 extends toward an opposite direction of the second retaining portion 221.

The third control terminal 23 has a third retaining portion 231, a third elastic arm 232, a raised portion 233, and a third soldering portion 234. The third retaining portion 231 has an insertion tab 235. The third retaining portion 231 is positioned in the third recess 113 of the insulating housing 1, and the insertion tab 235 is embedded in the third recess 113 to enhance a retention force thereof. The third elastic arm 232 has a touch portion 236 and a pressing portion 237. The touch portion 236 has a fixing end at an end thereof connecting with the third retaining portion 231. The touch portion 236 has a movable end at another end thereof extending into the insertion space 101 and toward the rear of the insulating housing 1. The pressing portion 237 has an end connecting with the movable end of the touch portion 236 to form a bent point 238. The pressing portion 237 has a free end 239 at another end thereof. The free end 239 of the pressing portion 237 is disposed at a corresponding lateral side of the second elastic arm 222 of the second control terminal 22 to form a gap therebetween in a normal status. The raised portion 233 connects with the free end 239 of the pressing portion 237 and extends toward an opposite direction of the second elastic arm 222. The third soldering portion 234 connects with the third retaining portion 231 and extends out of the insertion space 101.

The first set of terminals 31 is assembled outside the base plate 10 of the insulating housing 1.

The second set of terminals 32 is assembled inside the base plate 10 of the insulating housing 1.

The third set of terminals 33 is assembled on the rear of the insulating housing 1.

The first pressing plate 41 is fixed outside the base plate 10 and positions the first set of terminals 31.

The second pressing plate 42 is fixed inside the base plate 10 and positions the second set of terminals 32.

The rear pressing plate 43 has two protruding tabs 431 at an end thereof and another two protruding tabs 431 at another end thereof. The protruding tabs 431 are respectively clipped in the holding slots 103 of the first sidewall 11 and the second sidewall 12 of the insulating housing 1. The rear pressing plate 43 presses against a soldering portion of each of terminals of the first set of terminals 31, the second set of terminals 32, and the third set of terminals 33 to solder the terminals on a printed circuit board (not shown).

The cover 5 has a plurality of assembling pieces 50. Each of the first sidewall 11 and the second sidewall 12 of the insulating housing 1 has a plurality of assembling holes 104. The assembling pieces 50 respectively assemble into the assembling holes 104. Thereby, the cover 5 is assembled on the first sidewall 11 and the second sidewall 12 of the insulating housing 1, and the insertion space 101 is located between the cover 5 and the base plate 10 of the insulating housing 1. The cover 5 has two pressing pieces 51. The two pressing pieces 51 press against the third set of terminals 33.

The shielding casing 6 has a hooking arm 60 and a plurality of holding holes 61. Each of the first sidewall 11 and the second sidewall 12 of the insulating housing 1 respectively has a hooking portion 105 and a plurality of protrusions 106. The hooking arm 60 hooks on the hooking portion 105 of the first sidewall 11, and the protrusions 106 are respectively retained in the holding holes 61. Thereby, the shielding casing 6 is assembled on the first sidewall 11 and the second sidewall 12 of the insulating housing 1.

The card ejection mechanism 7 is arranged in the insertion space 101 of the insulating housing 1 for ejection of the electronic card 9 inserted in the insertion space 101 of the insulating housing 1.

Referring to FIGS. 1-6, the electronic card 9 has an anti-write element 90. The anti-write element 90 may be located in an anti-write status or in a write status. In this embodiment, the anti-write element 90 is switched to the place of the write status. When the electronic card 9 is inserted into the insertion space 101, the electronic card 9 pushes the push portion 216 of the first control terminal 21, moving the free end 219 of the elongation portion 217 toward the second retaining portion 221 of the second control terminal 22 to contact slidably thereon. The anti-write element 90 of the electronic card 9 presses against the bent point 218 of the first control terminal 21, such that the free end 219 of the elongation portion 217 contacts the second retaining portion 221 of the second control terminal 22, so as to transmit a signal to confirm that the electronic card 9 is in a write status. The elongation portion 217 of the first elastic arm 212 contacts the second retaining portion 221 of the second control terminal 22 in a slidable contacting manner, so that the first control terminal 21 has a better elasticity to avoid concentrating the force against on the first elastic arm 212 and a deformation of the first elastic arm 212 on the push portion 216. Therefore, the contact between the first control terminal 21 and the second control terminal 22 is much smoother and much more confirmable, the control terminals are much more durable, and the electronic card 9 is much more easily inserted in the card reading apparatus. The raised portion 213 of the first control terminal 21 also makes the contact and the slide of the free end 219 of the elongation portion 217 much smoother.

Moreover, when the electronic card 9 is inserted into the insertion space 101 and reaches its position, the electronic card 9 pushes the touch portion 236 of the third control terminal 23, moving the free end 239 of the pressing portion 237 toward the second elastic arm 222 of the second control terminal 22 to press thereon. The free end 239 of the pressing portion 237 of the third elastic arm 232 contacts the second elastic arm 222 of the second control terminal 22 in an elastic contacting manner. Therefore, the contact between the third control terminal 23 and the second control terminal 22 is much easier and much more confirmable, so as to ensure that the electronic card 9 electrically contacts with the first set of terminals 31, the second set of terminals 32, or the third set of terminals 33.

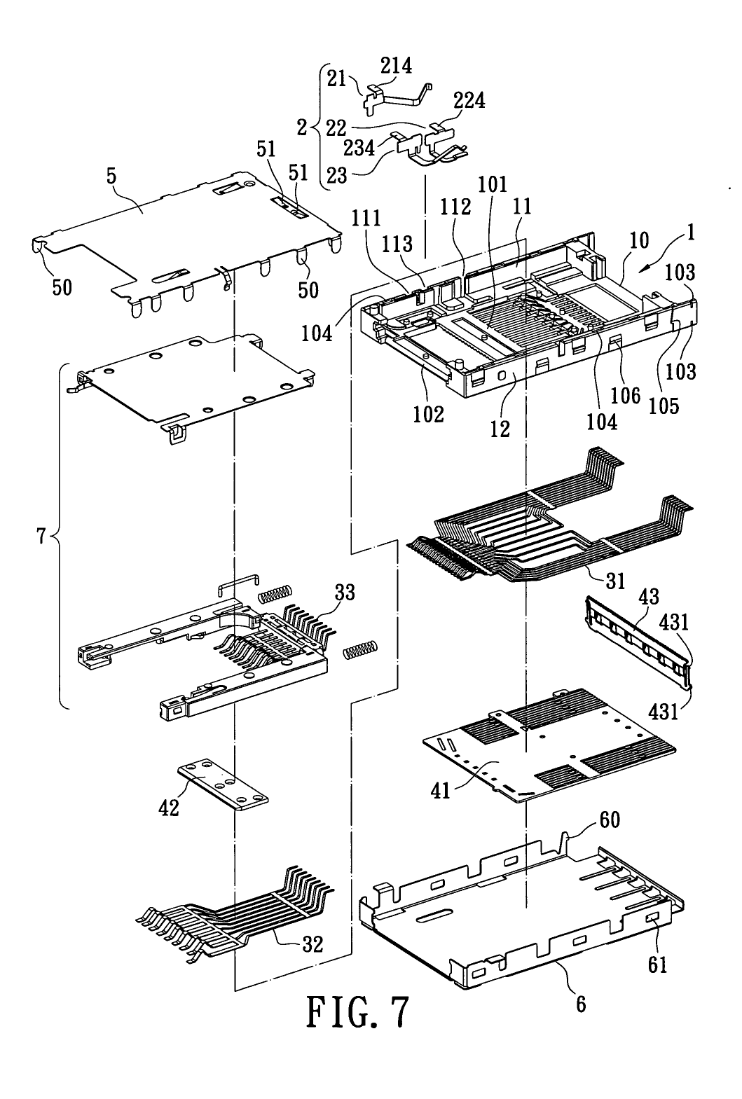

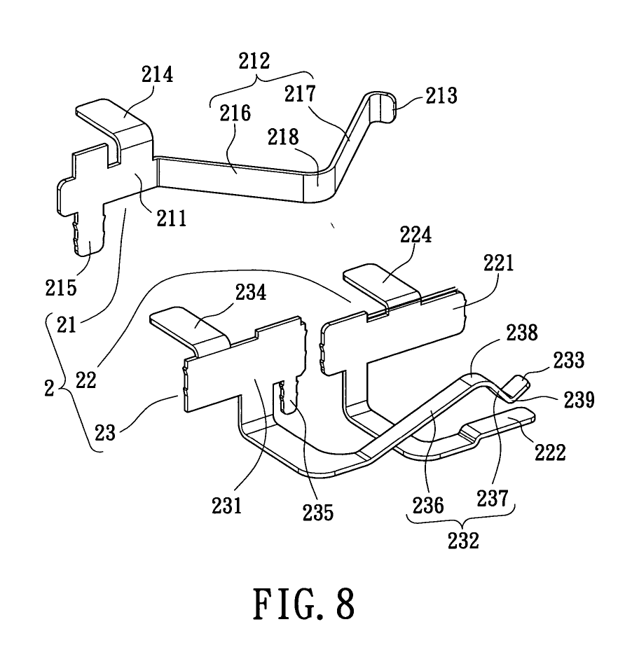

FIG. 7 and FIG. 8 show another embodiment of the card reading apparatus of the present invention. In this embodiment, a bending direction of a soldering portion of each of terminals of the first set of terminals 31, the second set of terminals 32, and the third set of terminals 33 is different from that of the soldering portion in the previous embodiment, and bending directions of the first soldering portion 214 of the first control terminal 21, the second soldering portion 224 of the second control terminal 22, and the third soldering portion 234 of the third control terminal 23 of the set of control terminals 2 are different from those of the soldering portions in the previous embodiment, so as to provide more design flexibility for soldering the terminals on a printed circuit board.

As indicated above, the card reading apparatus of the present invention has the following advantages:

(1) The elongation portion of the first elastic arm of the first control terminal contacts the second retaining portion of the second control terminal in a slidable contacting manner, so that the first control terminal has a better elasticity to avoid concentrating the force against the first elastic arm and a deformation of the first elastic arm on the push portion. Therefore, the contact between the first control terminal and the second control terminal is much smoother and much more confirmable, the control terminals are much more durable, and the electronic card is much more easily inserted in the card reading apparatus.

(2) The free end of the pressing portion of the third elastic arm of the third control terminal contacts the second elastic arm of the second control terminal in an elastic contacting manner. Therefore, the contact between the third control terminal and the second control terminal is much easier and much more confirmable.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A card reading apparatus for insertion of an electronic card therein, the card reading apparatus comprising:
an insulating housing having an insertion space formed therein and an insertion opening formed in a front thereof, the insertion opening communicating with the insertion space, wherein the electronic card is inserted into the insertion space through the insertion opening; and
a set of control terminals including a first control terminal and a second control terminal, the first control terminal having a first retaining portion and a first elastic arm, the first retaining portion being positioned in the insulating housing, the first elastic arm having a push portion and an elongation portion, the push portion having a fixing end at an end thereof connecting with the first retaining portion, the push portion having a movable end at another end thereof extending into the insertion space and toward a rear of the insulating housing, the elongation portion having an end connecting with the movable end of the push portion to form a bent point, the elongation portion having a free end at another end thereof, the second control terminal having a second retaining portion, the second retaining portion being positioned in the insulating housing, and the free end of the elongation portion being disposed at a corresponding lateral side of the second retaining portion to form a gap therebetween in a normal status; wherein
when the electronic card is inserted into the insertion space, the electronic card pushes the push portion, moving the free end of the elongation portion toward the second retaining portion to contact slidably thereon.

2. The card reading apparatus as claimed in claim 1, wherein the push portion has a length equal to that of the elongation portion of the first elastic arm of the first control terminal.

3. The card reading apparatus as claimed in claim 1, wherein the first retaining portion of the first control terminal has an insertion tab.

4. The card reading apparatus as claimed in claim 1, wherein the first control terminal has a raised portion connecting with the free end of the elongation portion and extending toward an opposite direction of the second retaining portion of the second control terminal.

5. The card reading apparatus as claimed in claim 1, wherein the first control terminal has a first soldering portion connecting with the first retaining portion and extending out from the insertion space.

6. The card reading apparatus as claimed in claim 1, wherein the second control terminal has a second soldering portion connecting with the second retaining portion and extending out of the insertion space.

7. The card reading apparatus as claimed in claim 1, wherein the second control terminal has a second elastic arm, the second elastic arm having a fixing end at an end thereof connecting with the second retaining portion, the second elastic arm having a free end at another end thereof extending into the insertion space and the rear of the insulating housing, the set of control terminals including a third control terminal, the third control terminal having a third retaining portion and a third elastic arm, the third retaining portion being positioned in the insulating housing, the third elastic arm having a touch portion and a pressing portion, the touch portion having a fixing end at an end thereof connecting with the third retaining portion, the touch portion having a movable end at another end thereof extending into the insertion space and toward the rear of the insulating housing, the pressing portion having an end connecting with the movable end of the touch portion to form a bent point, the pressing portion having a free end at another end thereof, and the free end of the pressing portion being disposed at a corresponding lateral side of the second elastic arm to form a gap therebetween in a normal status, wherein when the electronic card is inserted into the insertion space, the electronic card pushes the touch portion, moving the free end of the pressing portion toward the second elastic arm to press thereon.

8. The card reading apparatus as claimed in claim 7, wherein the third retaining portion of the third control terminal has an insertion tab.

9. The card reading apparatus as claimed in claim 7, wherein the third control terminal has a raised portion connecting with the free end of the pressing portion and extending toward an opposite direction of the second elastic arm of the second control terminal.

10. The card reading apparatus as claimed in claim 7, wherein the third control terminal has a third soldering portion connecting with the third retaining portion and extending outward the insertion space.

11. The card reading apparatus as claimed in claim 7, wherein the first control terminal is a protective terminal, the second control terminal is a common terminal, and the third control terminal is a detective terminal.

12. The card reading apparatus as claimed in claim 7, wherein the insulating housing has a base plate, a first sidewall, and a second sidewall, the first sidewall and the second sidewall respectively connecting with two opposite edges of the base plate to form the insertion space of the insulating housing therebetween, the first sidewall having a first recess, a second recess, and a third recess, the first recess, the third recess, and the second recess being arranged in sequence backward from the front of the insulating housing, the first retaining portion of the first control terminal, the second retaining portion of the second control terminal, and the third retaining portion of the third control terminal being positioned in the first recess, the second recess, and the third recess, respectively.

13. The card reading apparatus as claimed in claim 12, comprising a first set of terminals, a second set of terminals, a third set of terminals, a first pressing plate, a second pressing plate, and a rear pressing plate, the first set of terminals being assembled outside the base plate of the insulating housing, the first pressing plate being fixed outside the base plate and positioning the first set of terminals, the second set of terminals being assembled inside the base plate of the insulating housing, the second pressing plate being fixed inside the base plate and positioning the second set of terminals, the third set of terminals being assembled on the rear of the insulating housing, each of the first sidewall and the second sidewall of the insulating housing having two holding slots disposed at rear ends thereof, the rear pressing plate having two protruding tabs at an end thereof and another two protruding tabs at another end thereof, the protruding tabs being respectively clipped in the holding slots, and the rear pressing plate pressing against a soldering portion of each of terminals of the first set of terminals, the second set of terminals, and the third set of terminals.

14. The card reading apparatus as claimed in claim 12, comprising a cover, the cover being assembled on the first sidewall and the second sidewall of the insulating housing, and the insertion space being located between the cover and the base plate.

15. The card reading apparatus as claimed in claim 12, comprising a shielding casing assembled on the first sidewall and the second sidewall of the insulating housing.

16. The card reading apparatus as claimed in claim 12, comprising a card ejection mechanism arranged in the insertion space of the insulating housing.
